(19) United States
(12) Patent Application Publication
(10) Pub. No.: US 2009/0023565 A1
(43) Pub. Date: Jan. 22, 2009

(54) VIBRA BACK WAVE

(75) Inventor: Pearl Liang, Kearny, NJ (US)

Correspondence Address: BROWDY AND NEIMARK, P.L.L.C.;624 NINTH STREET, NW, SUITE 300, WASHINGTON, DC, 20001-5303, US

(73) Assignee: Health Mark, INC., Kearny, NJ (US)

(21) Appl. No.: 11/865,562

(22) Filed: Oct. 1, 2007

(30) Foreign Application Priority Data
Jul. 16, 2007 (TW) 96211575

(51) Int. Cl. A63B 21/00; A61H 1/00

(52) U.S. Cl. 482/142; 601/26

(57) ABSTRACT

A back stretching device includes a curved cushion having an elongated slot through top and bottom sides thereof, a housing mounted on the bottom side of the curved cushion, a motor mounted in the housing, and a rotating member accommodated in the housing and eccentrically connected with an output shaft of the motor. Thus, the back stretching device of the invention can be used to effectively stretch and relax a user's back muscles.

### BACKGROUND OF THE INVENTION

1. Field of the Invention

The present invention relates generally to exercise equipment, and more specifically to a back stretching device equipped with a vibrator.

2. Description of the Related Art

With the rapid advancement of the computer technology, the office workers have to sit for long time to work. If the sitting postures of the office workers are improper, additional stress will be borne at lower backs of the office workers, contributing to low back pain. In order to ease the low back pain, a curved back stretching plate is designed and commercially available. A user's spine can be stretched and the user's back muscles can be relaxed when the user lies down on the curved back stretching plate.

However, the user himself has to control his/her stretching motion when using the conventional back stretching plate to stretch the spine and relax the back muscles, resulting in a limited effect of stretch and relaxation when doing exercise on the conventional back stretching plate.

### SUMMARY OF THE INVENTION

The present invention has been accomplished in view of the above-noted circumstances. It is one objective of the present invention to provide a back stretching device, which can effectively stretch and relax user's back muscles.

To achieve this objective of the present invention, the back stretching device comprises a curved cushion having an elongated slot through top and bottom sides thereof, a housing mounted on the bottom side of the curved cushion a motor mounted in the housing, and a rotating member accommodated in the housing and eccentrically connected with an output shaft of the motor.

By means of aforesaid design, a user can lie down on the curved cushion to effectively stretch and relax the back muscles with the service of the rotating member.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a perspective view of the back stretching device according to a preferred embodiment of the present invention;

FIG. 2 is a bottom view of the back stretching device according to the preferred embodiment of the present invention, in which a cover is removed for illustrative purpose, and

FIG. 3 is a schematic drawing showing that the user lies down on the back stretching device.

### DETAILED DESCRIPTION OF THE INVENTION

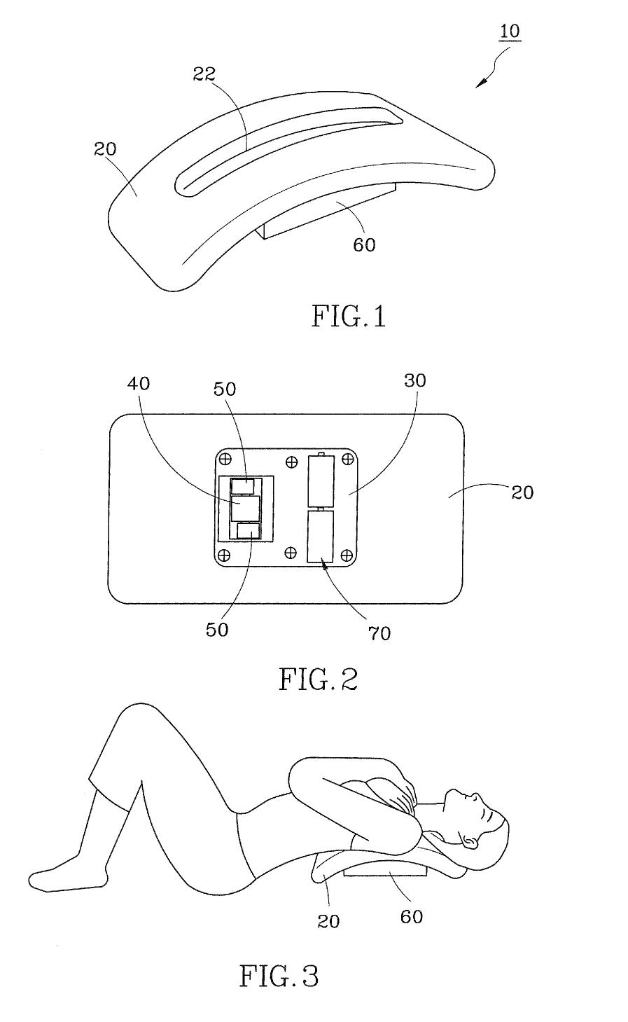

Referring to FIG. 1 and FIG. 2, a back stretching device 10 in accordance with a preferred embodiment of the present invention comprises a curved cushion 20, a housing 30, a motor 40, a pair of rotating members 50 and a cover 60.

The curved cushion 20 has an elongated slot 22 through top and bottom sides thereof for accommodation of a user's spine.

Referring to FIG. 2, the housing 30 is mounted on the bottom side of the curved cushion 20.

The motor 40 is configured to the housing 30 and electrically connected to batteries 70.

The rotating members 50 are disposed in the housing 30 and located at left and right sides of the motor 40 and eccentrically connected with an output shaft of the motor 40 such that the rotating members 50 can be driven by the motor 40 to rotate eccentrically, thereby generating vibration.

The cover 60 is fastened to the bottom side of the curved cushion 20 through a hook and loop fastener (not shown) and covers the housing 30 for preventing the housing 30, the motor 40 and the rotating members 50 from damage.

Referring to FIG. 3, when in use, the user may lie down on the top side of the curved cushion 20 to make the spine place in the elongated slot 22 of the curved cushion 20, and then alternatively stretch and release the back to attain an effect of spine stretch.

In addition, when the user lies down on the curved cushion 20, he/she can start the motor 40 by use of a switch (not shown) electrically connected to the batteries 70 to drive the rotating members 50 to rotate, and therefore the user's back muscles are massaged by the vibration generated by the eccentric rotation of the rotating members 50. By means of the aid of the vibration, the back muscles of the user can be effectively stretched and relaxed.

It is to be understood that the back stretching device 10 of the invention can not only be used to exercise the user's back but also the user's waist and the legs.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A back stretching device comprising:
a curved cushion having an elongated slot through top and bottom sides thereof;
a housing mounted on the bottom side of the curved cushion;
a motor mounted in the housing; and
a rotating member accommodated in the housing and eccentrically connected with an output shaft of the motor.

2. The back stretching device as claimed in claim 1, further comprising a cover detachably mounted on the bottom side of the curved cushion and covering the housing.
